(19) United States
(12) Patent Application Publication
(10) Pub. No.: US 2026/0198730 A1
(43) Pub. Date: Jul. 16, 2026

(54) Grinder Spring Pressure Regulating Assembly and Grinding Device Applying Same

(71) Applicant: HANDING ZHOU, Guangzhou (CN)

(72) Inventor: HANDING ZHOU, Guangzhou (CN)

(21) Appl. No.: 19/025,345

(22) Filed: Jan. 16, 2025

(51) Int. Cl. A47J 42/38; A47J 42/32

(52) U.S. Cl. CPC A47J 42/38; A47J 42/32

(57) ABSTRACT

Disclosed is a grinder spring pressure regulating assembly, including a spindle and a spring, wherein the spring sleeves the spindle, and a first positioning member and a second positioning member are respectively arranged on upper and lower sides of the spring; and a first trapezoidal groove and a second trapezoidal groove configured to match the spring are respectively provided in inner sides of the first positioning member and the second positioning member. The spring is arranged between the first positioning member and the second positioning member, and is fixed in position through the first trapezoidal groove and the second trapezoidal groove. When a grinder is in use, the spring will always maintain a fixed motion mode, without deviating from or making any adverse contact with the spindle, thus providing a stable and uniform pressure for the grinder.

### TECHNICAL FIELD

The present disclosure relates to the field of coffee grinding devices, in particular to a grinder spring pressure regulating assembly and a grinding device applying same.

### BACKGROUND

Coffee grinding is the operation of crushing roasted coffee beans. For grinding coffee, a coffee grinder is needed. Existing coffee grinder spring pressure regulating devices do not provide solid and stable fixation and support for the installation, pressure regulation and movement of springs, thus failing to provide uniform rotary grinding pressure for grinders, and further resulting in a poor grinding effect. Moreover, due to the mismatch between the spring and accessories, it is extremely likely to cause wear and tear of the accessories and produce abnormal noise, ultimately leading to product damage.

### SUMMARY

In order to solve the above problems, the present disclosure provides a grinder spring pressure regulating assembly and a grinding device applying same.

The present disclosure achieves the above objective through the following technical solutions:
The present disclosure provides a grinder spring pressure regulating assembly, including:
a spindle and a spring, where the spring sleeves the spindle, and a first positioning member and a second positioning member are respectively arranged on upper and lower sides of the spring;
a first trapezoidal groove and a second trapezoidal groove configured to match the spring are respectively provided at inner sides of the first positioning member and the second positioning member; and
a third trapezoidal groove configured to match a grinding head is provided in the other side of the first positioning member.

In some embodiments, the first trapezoidal groove, the second trapezoidal groove and the third trapezoidal groove are all in regular trapezoids.

The present disclosure also provides a grinding device, which also includes an inner sleeve and a long shaft sleeve, where the long shaft sleeve is arranged inside the inner sleeve, and the long shaft sleeve is connected to an inner wall of the inner sleeve by means of connecting plates.

In some embodiments, the spindle is inserted into the long shaft sleeve, a third positioning member is provided in cooperation at an upper end of the long shaft sleeve for supporting an upper part of the spindle, and the second positioning member is provided in cooperation at a lower end of the long shaft sleeve for supporting a lower part of the spindle.

In some embodiments, a stepped groove is provided in the lower end of the long shaft sleeve, and the other side of the second positioning member is arranged as a plane matching the stepped groove.

In some embodiments, the spindle is in clearance fit with a shaft hole in the middle of the third positioning member, and the spindle is in clearance fit with a shaft hole in the middle of the second positioning member.

In some embodiments, the second positioning member is in close fit with the stepped groove in the lower end of the long shaft sleeve, and the third positioning member is in close fit with the upper end of the long shaft sleeve.

In some embodiments, there are a plurality of connecting plates, and the connecting plates are evenly distributed along a peripheral side of the spindle.

In some embodiments, the grinding head includes a connecting jacket and a grinding body, the connecting jacket being in a two-piece type and connected to an end portion of the spindle, a connecting key being formed at the end portion of the spindle, and the connecting key being located at a gap in the two-piece connecting jacket; and
the connecting jacket is matched with the third trapezoidal groove.

In some embodiments, the grinding body is in a circular truncated cone shape, a plurality of grinding ribs are provided on a lower surface of the grinding body, and the grinding ribs are evenly distributed along a circumferential direction.

The present disclosure has the beneficial effects that the spring is arranged between the first positioning member and the second positioning member, and is fixed in position through the first trapezoidal groove and the second trapezoidal groove. When a grinder is in use, the spring will always maintain a fixed motion mode, without deviating from or making any adverse contact with the spindle, thus providing a stable and uniform pressure for the grinder.

### BRIEF DESCRIPTION OF FIGURES

In order to describe the embodiments of the present disclosure or the technical solution in the related art more clearly, brief introduction on drawings needed to be used in description of the embodiments and the related art will be made below. Apparently, the drawings in the description below are some embodiments of the present disclosure, and a person of ordinary skill in the art further can obtain other drawings according to the drawings without making creative efforts.

FIG. 1 is a front view structural diagram of a grinder spring pressure regulating assembly according to the present disclosure;

FIG. 2 is an A-A sectional view of FIG. 1;

FIG. 3 is an exploded view of the grinder spring pressure regulating assembly according to the present disclosure;

FIG. 4 is a front view of a grinding device according to the present disclosure;

FIG. 5 is a B-B sectional view of FIG. 4;

FIG. 6 is a three-dimensional view of the grinding device according to the present disclosure; and

FIG. 7 is an exploded view of the grinding device according to the present disclosure.

### DESCRIPTION OF REFERENCE NUMERALS

1 denotes a spindle; 2 denotes a first positioning member; 201 denotes a first trapezoidal groove; 3 denotes a spring; 4 denotes a second positioning member; 401 denotes a second trapezoidal groove; 402 denotes a third trapezoidal groove; 5 denotes a grinding head; 501 denotes a connecting jacket; 502 denotes a grinding body; 503 denotes a grinding rib; 6 denotes a long shaft sleeve; 7 denotes an inner sleeve; 8 denotes a connecting plate; and 9 denotes a third positioning member.

### DETAILED DESCRIPTION

In order to make objectives, technical solutions and advantages of the present disclosure clearer, the technical solution of the present disclosure will be further described in detail below. Apparently, the described embodiments are merely a part of embodiments of the present disclosure and are not all the embodiments. On the basis of the embodiments in the present disclosure, all other implementations obtained by a person of ordinary skill in the art without creative efforts fall into the scope of protection of the present disclosure.

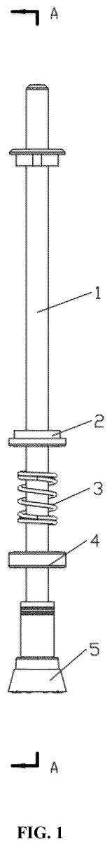

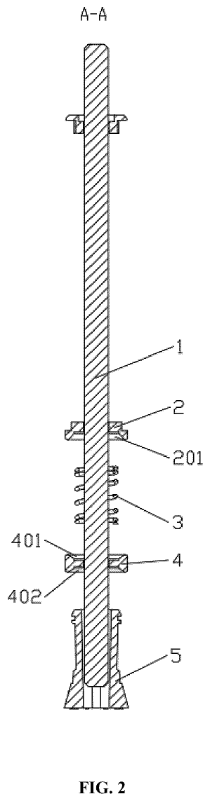

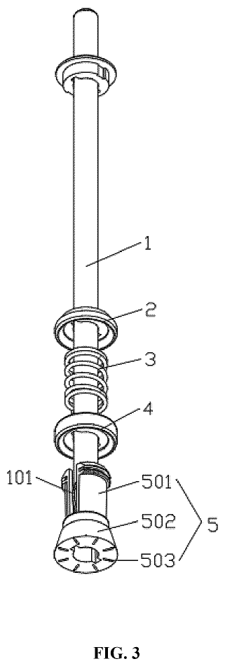

Referring to FIG. 1 to FIG. 3, the present disclosure provides a grinder spring pressure regulating assembly, including: a spindle 1 and a spring 3, where the spring 3 sleeves the spindle 1, and a first positioning member 2 and a second positioning member 4 are respectively arranged on upper and lower sides of the spring 3. A first trapezoidal groove 201 and a second trapezoidal groove 401 configured to match the spring 3 are respectively provided at inner sides of the first positioning member 2 and the second positioning member 4. The spring 3 can be fixed in position through the first trapezoidal groove 201 and the second trapezoidal groove 401, thus avoiding deviation of the spring 3 during movement. A third trapezoidal groove 402 configured to match a grinding head 5 is provided in the other side of the first positioning member 2.

In the above structure, the spring 3 is arranged between the first positioning member 2 and the second positioning member 4, and is fixed in position through the first trapezoidal groove 201 and the second trapezoidal groove 401. When a grinder is in use, the spring 3 will always maintain a fixed motion mode, without deviating from or making any adverse contact with the spindle 1, thus providing a stable and uniform pressure for the grinder.

In some embodiments, the first trapezoidal groove 201, the second trapezoidal groove 401 and the third trapezoidal groove 402 are all in regular trapezoids.

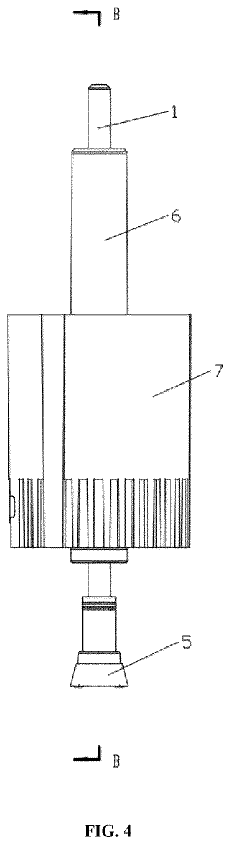

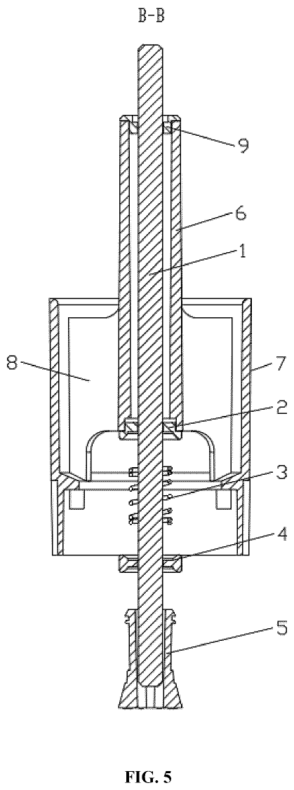

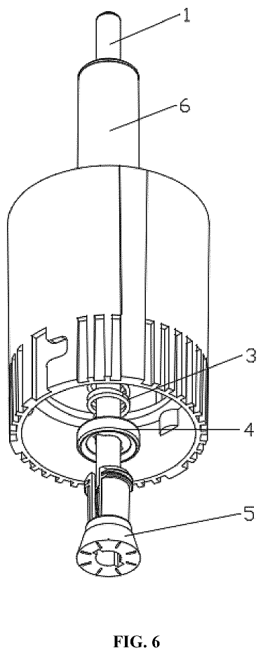

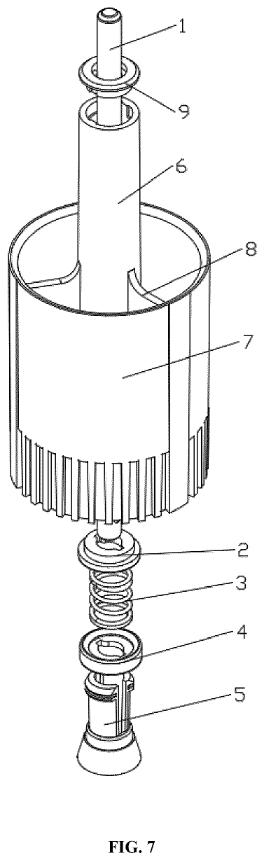

Referring to FIG. 4 to FIG. 7, the present disclosure provides a grinding device which includes the grinder spring pressure regulating assembly and also includes an inner sleeve 7 and a long shaft sleeve 6. The long shaft sleeve 6 is arranged inside the inner sleeve 7, and the long shaft sleeve 6 is connected to an inner wall of the inner sleeve 7 by means of a connecting plate 8, which can increase the connection strength between the long shaft sleeve 6 and the inner sleeve 7. In order to improve the connection stability between the long shaft sleeve 6 and the inner sleeve 7, a plurality of connecting plates 8 are provided, and the connecting plates 8 are evenly distributed along a peripheral side of the spindle 1.

Further, the spindle 1 is inserted into the long shaft sleeve 6, a third positioning member 9 is provided in cooperation at an upper end of the long shaft sleeve 6 for supporting an upper part of the spindle 1, and the second positioning member 4 is provided in cooperation at a lower end of the long shaft sleeve 6 for supporting a lower part of the spindle 1, so that the movement stability of the spindle 1 is maintained.

In some embodiments, a stepped groove is provided in the lower end of the long shaft sleeve 6, and the other side of the second positioning member 4 is arranged as a plane matching the stepped groove.

In some embodiments, the spindle 1 is in clearance fit with a shaft hole in the middle of the third positioning member 9, and the spindle 1 is in clearance fit with a shaft hole in the middle of the second positioning member 4. The second positioning member 4 is in close fit with the stepped groove in the lower end of the long shaft sleeve 6, and the third positioning member 9 is in close fit with the upper end of the long shaft sleeve 6.

In the above-mentioned solution of the grinding device, when in use, an upper end of the grinding head 5 is matched with the third trapezoidal groove 402 of the first positioning member 2, the grinding head 5 is in fixed locking connection with the spindle 1, and by pressing the inner sleeve 7, the second positioning member 4 is enabled to press the spring 3, thereby adjusting the pressure on the grinding head 5 and controlling the magnitude of the grinding force.

In some embodiments, the grinding head 5 includes a connecting jacket 501 and a grinding body 502. The connecting jacket 501 is in a two-piece type and connected to an end portion of the spindle 1. A connecting key is formed at the end portion of the spindle 1. The connecting key is located at a gap in the two-piece connecting jacket 501. The connecting jacket 501 is matched with the third trapezoidal groove 402. When in use, the connecting jacket 501 is locked to the spindle 1 through a locking element so as to maintain the stability of the grinding head 5.

In some embodiments, the grinding body 502 is in a circular truncated cone shape. A plurality of grinding ribs 503 are provided on a lower surface of the grinding body 502, and the grinding ribs 503 are evenly distributed along a circumferential direction.

The above is merely the specific implementations of the present disclosure and is not intended to limit the scope of protection of the present disclosure. Any variations or replacements apparent to a person skilled in the art within the technical scope disclosed by the present disclosure shall fall within the scope of protection of the present disclosure. Therefore, the scope of protection of the present disclosure shall be subject to the scope of protection of the claims.

What is claimed is:

1. A grinder spring pressure regulating assembly, comprising: a spindle and a spring, wherein the spring sleeves the spindle, and a first positioning member and a second positioning member are respectively arranged on upper and lower sides of the spring;
a first trapezoidal groove and a second trapezoidal groove configured to match the spring are respectively provided at inner sides of the first positioning member and the second positioning member; and
a third trapezoidal groove configured to match a grinding head is provided in the other side of the first positioning member.

2. The grinder spring pressure regulating assembly according to claim 1, wherein the first trapezoidal groove, the second trapezoidal groove and the third trapezoidal groove are all in regular trapezoids.

3. A grinding device applying the grinder spring pressure regulating assembly according to claim 2, further comprising an inner sleeve and a long shaft sleeve, wherein the long shaft sleeve is arranged inside the inner sleeve, and the long shaft sleeve is connected to an inner wall of the inner sleeve by a connecting plate.

4. The grinding device according to claim 3, wherein the spindle is inserted into the long shaft sleeve, a third positioning member is provided in cooperation at an upper end of the long shaft sleeve for supporting an upper part of the spindle, and the second positioning member is provided in cooperation at a lower end of the long shaft sleeve for supporting a lower part of the spindle.

5. The grinding device according to claim 4, wherein a stepped groove is provided in the lower end of the long shaft sleeve, and the other side of the second positioning member is arranged as a plane matching the stepped groove.

6. The grinding device according to claim 5, wherein the spindle is in clearance fit with a shaft hole in the middle of the third positioning member, and the spindle is in clearance fit with a shaft hole in the middle of the second positioning member.

7. The grinding device according to claim 5, wherein the second positioning member is in close fit with the stepped groove in the lower end of the long shaft sleeve, and the third positioning member is in close fit with the upper end of the long shaft sleeve.

8. The grinding device according to claim 3, wherein a plurality of connecting plates are provided, and the connecting plates are evenly distributed along a peripheral side of the spindle.

9. The grinding device according to claim 3, wherein the grinding head comprises a connecting jacket and a grinding body, the connecting jacket being in a two-piece type and connected to an end portion of the spindle, a connecting key being formed at the end portion of the spindle, and the connecting key being located at a gap in the two-piece connecting jacket; and
the connecting jacket is matched with the third trapezoidal groove.

10. The grinding device according to claim 9, wherein the grinding body is in a circular truncated cone shape, a plurality of grinding ribs are provided on a lower surface of the grinding body, and the grinding ribs are evenly distributed along a circumferential direction.
